(19) United States
(12) Patent Application Publication
(10) Pub. No.: US 2023/0218465 A1
(43) Pub. Date: Jul. 13, 2023

(54) METHOD FOR CONTROLLING PNEUMATIC GLOVE AND DEVICE FOR POWER-ASSISTED TRAINING FOR HAND OF PATIENT

(71) Applicant: Shanghai Siyi Intelligent Technology Co., Ltd., Shanghai (CN)

(72) Inventors: Wudong WANG, Shanghai (CN); Yajun ZHANG, Pudong New Area (CN); Ganggang YIN, Shanghai (CN); Zhongzhe CHEN, Shanghai (CN); Lingfeng PENG, Pudong New Area (CN); Kaiyan ZHANG, Pudong New Area (CN)

(73) Assignee: Shanghai Siyi Intelligent Technology Co., Ltd., Shanghai (CN)

(21) Appl. No.: 18/181,380

(22) Filed: Mar. 9, 2023

Related U.S. Application Data
(63) Continuation of application No. PCT/CN2021/118449, filed on Sep. 15, 2021.

(30) Foreign Application Priority Data
Sep. 16, 2020 (CN) 202010974260.4
Jan. 19, 2021 (CN) 202110070770.3
Sep. 15, 2021 (WO) PCTCN2021118449

(51) Int. Cl. A61H 1/02

(52) U.S. Cl. CPC A61H 1/0288; A61H 2201/1638; A61H 2201/165; A61H 2201/1238; A61H 2201/1409; A61H 2201/5056; A61H 2201/5025

(57) ABSTRACT

A method for controlling a pneumatic glove includes: S1, regulating an air pressure of a pneumatic glove to enable the pneumatic glove to be in a natural flexion state, and obtaining a current air pressure value of the pneumatic glove, detected by an air pressure detection unit at a current moment, as an initial air pressure; S2, setting an air pressure threshold according to the initial air pressure; adjusting an internal air path of the pneumatic gloves to a closed air path, and when the pneumatic glove is worn on a hand of a patient, obtaining the current air pressure of the pneumatic glove detected by the air pressure detection unit, and determining an expected movement trend of the hand of the patient according to the current air pressure and air pressure threshold; S3, regulating the air pressure in the pneumatic glove according to the expected movement trend.

### CROSS-REFERENCE TO RELATED APPLICATIONS

This present application claims the benefits of priorities to Chinese patent application No. 2020109742604, filed on Sep. 16, 2020, and Chinese patent application No. 2021100707703, filed on Jan. 19, 2021. The disclosure of the above applications is incorporated herein by reference.

### FIELD OF TECHNOLOGY

The present disclosure relates to the technical field of rehabilitation medical equipment, in particular to a method for controlling a pneumatic glove and device for power-assisted training for a hand of a patient.

### BACKGROUND

Stroke, the name of Chinese medicine disease, can be divided into endogenous wind and exopathic wind. Endogenous wind is caused by exogenous pathogenic factors (pathogenic influence), which is called stroke in Treatise on Febrile Diseases (also known as cassia twig decoction syndrome); exopathic wind belongs to internal injury syndrome, also known as cerebral stroke, apoplexy, etc. It is generally called apoplexy in modern times, which refers to the type of apoplexy with internal injury syndrome, and is mostly caused by the disorder of qi and blood, the obstruction of brain veins or the overflow of blood in the brain. Diseases mainly manifested by sudden fainting, hemiplegia, numbness of limbs, tongue silence, skewed mouth and tongue, and partial numbness. It also has the characteristics of acute, onset and rapid change, such as migrant and variable characteristics of the pathogenic influence.

For patients with early stroke, rehabilitation treatment is needed, especially for patients' hands, such as finger joints, and because of the small hand strength and small range of motion of hand joints, rehabilitation training is needed.

In the prior art, for example, the utility model with an application No. 201920435101.X and entitled of hand rehabilitation training device discloses a hand rehabilitation training device, which includes a control means and a rehabilitation glove which are communicated through air pipes; wherein the control means is further provided with an electrical stimulation output module, a panel of the control means is provided with an electrical stimulation output interface, and the electrical stimulation output interface is connected to electrode pads attached to forearms via electrode wires. The utility model can increase the rehabilitation training of the wrist and the forearm on the basis of realizing the rehabilitation training of the fingers, thereby further improving the rehabilitation effect of the hemiplegic patient.

However, the traditional rehabilitation training devices directly adopt passive training method, that is, help patients complete training directly through external equipment. Although it can achieve the purpose of training, but for the hand of the patient training effect is not very good, and cannot be based on the patient's real will to train.

Therefore, it is necessary to provide a novel method and device for power-assisted training for a hand of a patient to solve the above problems in the prior art.

### SUMMARY

Some embodiments of the present disclosure provide a method for controlling a pneumatic glove, which assists patients to carry out power-assisted training by measuring hand motions of patients, so as to improve the effect of rehabilitation training of patients.

In order to achieve the above purpose, the present disclosure discloses a method for controlling a pneumatic glove, including following steps:

S1, regulating an air pressure of a pneumatic glove to enable the pneumatic glove to be in a natural flexion state, and obtaining an air pressure value of the pneumatic glove at a current moment as an initial air pressure;

S2, wearing the pneumatic glove on a hand of a patient, measuring a magnitude or a change rate of a current air pressure of the pneumatic glove, and determining, by a control part, an expected movement trend of the hand of the patient according to the magnitude or the change rate of current air pressure;

S3, regulating, by the control part, the air pressure in the pneumatic glove according to the expected movement trend, so that the pneumatic glove moves according to the expected movement trend, to drive the hand of the patient to move.

The present disclosure has the beneficial effects that: after the patient wears the pneumatic glove, an air pressure threshold is set according to an initial state of the pneumatic glove, and by measuring the air pressure in the pneumatic glove and comparing it with the air pressure threshold, the expected movement trend that the patient wants to carry out can be determined, the pneumatic glove is regulated by a pneumatic device, so that the pneumatic glove drives the hand of the patient to move in a direction of the expected movement trend, helps the patient to carry out power-assisted training according to the patient's active will, and the patient's active participation is improved according to the patient's active will to help the patient carry out booster training to improve the rehabilitation effect.

Further, the control part sets an air pressure threshold according to the initial air pressure, and the air pressure threshold includes an air pressure stretching threshold or an air pressure flexion threshold.

Further, the process of step S2 includes:

determining, by the control part, a magnitude between the current air pressure, the air pressure stretching threshold and the air pressure flexion threshold;

determining, by the control part, that the hand of the patient has a stretching movement trend when the current air pressure is greater than the air pressure stretching threshold; and

determining, by the control part, that the hand of the patient has a flexion movement trend when the current air pressure is less than the air pressure flexion threshold. The present disclosure has the beneficial effects of setting the air pressure stretching threshold and the air pressure flexion threshold through the initial air pressure, and measuring the air pressure value in the pneumatic glove to determine the movement trend of the hand of the patient by comparing the air pressure value with the air pressure stretching threshold and the air pressure flexion threshold, thereby providing assistance for the subsequent patient's motions, realizing the power-assisted training of the hand of the patient, accurately grasping the movement trend of the patient to realize the power-assisted training and improving the training participation of the patient.

Further, the process of step S2 further includes:

measuring, by an air pressure measurement unit, the change rate of the current air pressure inside the pneumatic glove;

determining, by the control part, that the hand of the patient has the stretching movement trend when the change rate of the current air pressure is greater than 0; and

determining, by the control part, that the hand of the patient has the flexion movement trend when the change rate of the current air pressure is less than 0. The present disclosure has the beneficial effects that the movement trend of the hand of the patient is determined through the change rate of the current air pressure, which ensures that the movement trend of the hand of the patient can be quickly determined under different conditions, so as to facilitate the assistance rehabilitation training of the hand of the patient.

Further, when it is determined that the hand of the patient has the stretching movement trend, the control part controls a pneumatic device to output negative pressure according to the expected movement trend until the air pressure in the pneumatic glove reaches a negative pressure extreme value, to cause the pneumatic glove to assist the hand of the patient to carry out a stretching movement. The present disclosure has the beneficial effects that: the pneumatic glove can be stretched by outputting negative pressure to the pneumatic glove, thereby helping the hand of the patient to complete stretching training, helping the patient to actively participate in training, so as to improve the effect of the rehabilitation training.

Further, when it is determined that the hand of the patient has the flexion movement trend, the control part controls a pneumatic device to output positive pressure according to the expected movement trend until the air pressure in the pneumatic glove reaches a positive pressure extreme value, to cause the pneumatic glove to assist the hand of the patient to carry out a flexion movement. The present disclosure has the beneficial effects that: the pneumatic glove assists the hand of the patient to carry out the flexion movement by controlling the pneumatic device to output positive pressure to the pneumatic glove, and helps the patient to actively participate in training, so as to improve the effect of rehabilitation training.

Further, after the pneumatic glove moves according to the expected movement trend and drives the hand of the patient to move, the method further includes:

causing the pneumatic glove to return to a natural flexion state by turning on an on-off switch or controlling the pneumatic device to output air pressure to the pneumatic glove through the control part. The present disclosure has the beneficial effects that: after completing the power-assisted training for the hand of the patient, by stopping the output of air pressure or turning off the on-off switch, the air pressure in the pneumatic glove is restored to be close to the atmospheric pressure, so that the pneumatic glove restores to the natural state, and completes a measurement process of a training cycle, so that the hand of the patient motion measurement can be continued and the power-assisted training process can be completed, thus realizing a periodic power-assisted training.

Further, the process of causing the pneumatic glove to return to a natural flexion state by controlling the pneumatic device to output air pressure to the pneumatic glove through the control part includes:

measuring the internal air pressure value of the pneumatic glove and determining the internal air pressure value to be positive or negative;

controlling, by the control part, the pneumatic device to output negative pressure to the pneumatic glove until the pneumatic glove returns to the natural flexion state when the internal air pressure value is determined to be positive; and

controlling, the control part, the pneumatic device to output positive pressure to the pneumatic glove until the pneumatic glove returns to the natural flexion state when the internal air pressure value is determined to be negative.

Further, the step S1 includes: communicating the pneumatic glove with external atmospheric pressure to keep the air pressure value in the pneumatic glove consistent with the external atmospheric pressure, so that the pneumatic glove is in the natural flexion state, and obtaining the air pressure value of the pneumatic glove at a current moment as the initial air pressure.

The present disclosure further provides a device for power-assisted training for a hand of a patient, including a pneumatic glove, a control part, an output port, an air pressure measurement unit and a pneumatic device, wherein the pneumatic glove is pneumatically connected to the pneumatic device through the output port, the control part is connected to the pneumatic device to control the pneumatic device so that the pneumatic device outputs positive pressure, negative pressure or stops output to the pneumatic glove, the air pressure measurement unit is connected to the output port to measure air pressure data of the pneumatic glove in real time, and an output terminal of the air pressure measurement unit is electrically connected to the control part to output the measured air pressure data.

The present disclosure has the beneficial effects that: after the patient wears the pneumatic glove, the air pressure in the pneumatic glove is measured by the air pressure measurement unit, and a movement trend of the hand of the patient is determined by the air pressure change, so that the pneumatic device outputs the air pressure to the pneumatic glove according to the movement trend, and the pneumatic glove drives the hand of the patient to assist in the power-assisted training, thereby helping the patient to complete the power-assisted training process.

Further, when the pneumatic glove is in a natural flexion state, an air pressure inside the pneumatic glove is consistent with an air pressure of external atmosphere.

Further, the device further includes an on-off switch, the on-off switch is connected to the output port to control an on-off of the pneumatic glove and the external atmosphere, and is further electrically connected to the control part.

### BRIEF DESCRIPTION OF THE DRAWINGS

FIG. 1 is a schematic diagram of a workflow of a method for controlling a pneumatic glove of the present disclosure;

FIG. 2 is a schematic diagram of a specific workflow of step S2 in the method for controlling a pneumatic glove of the present disclosure;

FIG. 3 is a schematic diagram of a detailed implementing process of the method for controlling a pneumatic glove of the present disclosure;

FIG. 4 is a composite structure diagram of a device for controlling a pneumatic glove of the present disclosure;

FIG. 5 is a structural schematic diagram of a pneumatic glove of the present disclosure;

FIG. 6 is a structural diagram of a first movement assistance unit shown in FIG. 5 of the present disclosure; and

FIG. 7 is a schematic diagram of an operating state of the first movement assistance unit shown in FIG. 5 in which the first movement assistance unit performs a flexion movement according to the present disclosure.

### DESCRIPTION OF THE EMBODIMENTS

In order to make objectives, technical solutions, and advantages of the disclosure clearer, the technical solutions in the present disclosure are described clearly and completely in the following with reference to accompanying drawings in the embodiments of the disclosure. Apparently, the described embodiments are only part rather than all of the embodiments of the disclosure. Based on the embodiments of the present disclosure, all the other embodiments obtained by those of ordinary skill in the art without inventive effort are within the scope of the present disclosure. Unless otherwise mentioned, all technical and scientific terms used herein have the same meaning as commonly understood by one of ordinary skill in the art to which the present disclosure belongs. The term “including” and the like as used herein means that the elements or articles appearing before the term encompass the enumerated elements or articles appearing after the term and their equivalents, without excluding other elements or articles.

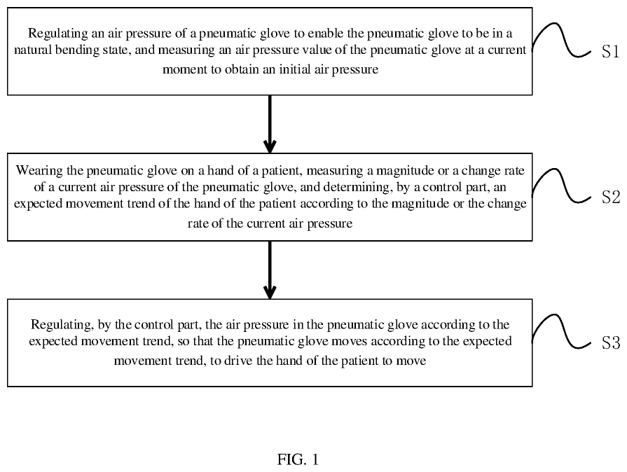

Aiming at the problems existing in the prior art, as shown in FIG. 1, the embodiments of the present disclosure provide a method for controlling a pneumatic glove, including:

S1, regulating an air pressure of a pneumatic glove to enable the pneumatic glove to be in a natural flexion state, and obtaining an air pressure value of the pneumatic glove at a current moment as an initial air pressure.

Under the condition that the pneumatic glove has no external output pneumatic power, the pneumatic glove is in a natural flexion state, the natural flexion state means that the air pressure in the pneumatic glove is equal to the external atmospheric pressure. Under normal circumstances, the external atmospheric pressure is equal to the standard atmospheric pressure. That is, the air pressure in the pneumatic glove is the same as the standard atmospheric pressure, but the external atmospheric pressure will also be affected by natural conditions, such as altitude and weather. Therefore, the air pressure in the pneumatic glove in a natural flexion state will fluctuate slightly, that is, the natural flexion state means that the air pressure in the pneumatic glove is roughly equal to the standard atmospheric pressure. Generally, when the pneumatic glove is in the natural flexion state, the difference between the air pressure in the pneumatic glove and the standard atmospheric pressure is −20 kPa to 20 kPa, that is, the initial air pressure is −20 kPa to 20 kPa. In other words, the initial air pressure is a relative value of the external atmospheric pressure at which the pneumatic gloves are in a natural bending state.

The initial air pressure is the difference between the air pressure on the pneumatic glove when the pneumatic glove flexes naturally and the standard atmospheric pressure. The atmospheric pressure can be output to the inside of the pneumatic glove through a pneumatic device to enable the pneumatic glove to be in a natural flexion state. Also, air paths in the pneumatic glove can be connected to the external atmospheric pressure by turning off an on-off switch of the pneumatic glove so that the pneumatic glove is in a natural flexion state. By making the pneumatic glove in the natural flexion state, when the air pressure change caused by the motion of the patient is subsequently measured, a motion measurement error caused by air leakage or air intake due to too large a difference with the atmospheric pressure can be avoided, and the measurement accuracy of the motion of the patient can be improved.

Further, an air pressure threshold includes an air pressure stretching threshold and an air pressure flexion threshold, the air pressure stretching threshold is greater than the air pressure flexion threshold, and the air pressure stretching threshold and the air pressure flexion threshold are both set by the initial air pressure.

S2, wearing the pneumatic glove on a hand of a patient, measuring a magnitude or a change rate of a current air pressure of the pneumatic glove by an air pressure measurement unit, and determining, by a control part, an expected movement trend of the hand of the patient according to the magnitude or the change rate of the current air pressure.

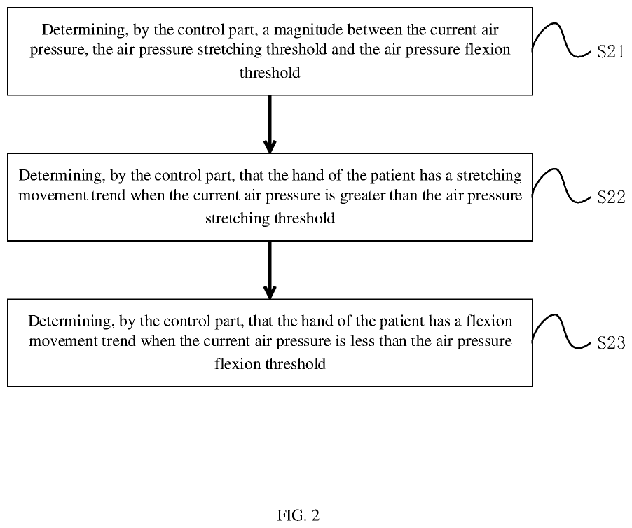

Further, as shown in FIG. 2, the specific process includes:

S21, determining, by the control part, a magnitude between the current air pressure, the air pressure stretching threshold and the air pressure flexion threshold;

S22, determining, by the control part, that the hand of the patient has a stretching movement trend when the current air pressure is greater than the air pressure stretching threshold; and

S23, determining, by the control part, that the hand of the patient has a flexion movement trend when the current air pressure is less than the air pressure flexion threshold.

Further, the pressure stretching threshold is a sum of the initial pressure and a stretching error value, and the stretching error value is a pressure value greater than 0, different stretching error values are selected according to specific conditions to determine the pressure stretching threshold.

In some embodiments, the process of step S2 further includes:

measuring, by an air pressure measurement unit, the change rate of the current air pressure inside the pneumatic glove;

determining, by the control part, that the hand of the patient has the stretching movement trend when the change rate of the current air pressure is greater than 0; and

determining, by the control part, that the hand of the patient has the flexion movement trend when the change rate of the current air pressure is less than 0.

The movement trend of the hand of the patient is determined through the change rate of the current air pressure, which ensures that the movement trend of the hand of the patient can be quickly determined under different conditions, so as to facilitate the assistance rehabilitation training of the hand of the patient.

It should be noted that the change rate of the current air pressure here refers to an average air pressure change rate when the air pressure inside the pneumatic glove changes from the initial air pressure to the current air pressure, so as to determine the change trend of the pneumatic glove from the initial air pressure to the current air pressure, so as to determine the movement trend of the hand of the patient.

Further, the pressure flexion threshold is a difference obtained by subtracting a flexion error value from the initial pressure, and the flexion error value is a pressure value greater than 0, different flexion error values are selected according to specific conditions to determine the pressure flexion threshold.

By setting the stretching error value, the air pressure change caused by stretching of the hand of the patient activity will not easily reach the air pressure stretching threshold, thereby avoiding the wrong assistance caused by a too small movement range of the patient, and reducing the misjudgment of the hand activity of the patient. By setting the flexion error value, the air pressure change caused by the flexion of the hand of the patient will not easily reach the air pressure flexion threshold, thereby avoiding the wrong assistance caused by a too small movement range of the patient, and reducing the misjudgment of the hand activity of the patient.

Since it is considered that the air pressure error in actual use and the small air pressure change caused by small movements are not the basis for determining the movement trend of the pneumatic glove, the stretching error value and flexion error value are set so that the movement trend of the hand of the patient can be determined only when the air pressure inside the pneumatic glove is greater than the air pressure stretching threshold or less than the air pressure flexion threshold when the patient that wears the pneumatic glove is moving the hand.

In specific use, when the pneumatic glove is in the natural flexion state, a deformation occurs inside the pneumatic glove due to the hand motion of the patient that wears the pneumatic glove, thereby causing bellows outside the pneumatic glove to deform to a certain extent. When the bellows are deformed, the air pressure inside the pneumatic glove changes, and for the change of air pressure caused by some small movements, sometimes, it misleads the motion determination, so that the misjudgment is caused. Through the set stretching error value and the flexion error value, when the pressure changes caused by subtle movements of the hand of the patient, there will be no misjudgment, thereby measuring the movement trend of the hand of the patient more accurately and reducing the occurrence of misjudgment.

When the hand of the patient moves wearing on the pneumatic glove, when the hand of the patient tends to stretch, the bellows of the pneumatic glove are compressed, which makes the air pressure value of the air path in the pneumatic glove become larger, and the bellows are part of the air path of the pneumatic glove. In other words, the bellows of the pneumatic glove are compressed, the volume of the air path in the pneumatic glove decreases, and the air pressure value of the closed air path in the pneumatic glove increases. And when the hand of the patient tends to flexion, the bellows outside the pneumatic glove are stretched, which reduces the air pressure value of the air path in the pneumatic glove. In other words, the bellows of the pneumatic glove are stretched, the volume of the air path in the pneumatic glove increases, and the air pressure value of the closed air path in the pneumatic glove decreases.

It should be noted that when the control part determines the change trend of the pneumatic glove according to the air pressure data in the pneumatic glove, it can determine the movement trend of the hand of the patient on the pneumatic glove by comparing the current air pressure and the air pressure threshold, or determine the movement trend of the hand of the patient on the pneumatic glove by the change rate of the current air pressure, or determine the movement trend of the hand of the patient on the pneumatic glove comprehensively by combining the current air pressure and the change rate of the current air pressure, which can be selected according to the actual use, so as to achieve better judgment effect.

S3, regulating, by the control part, the air pressure in the pneumatic glove according to the expected movement trend, so that the pneumatic glove moves according to the expected movement trend, to drive the hand of the patient that wears the pneumatic glove to move.

Further, the specific process of regulating, by the control part, the air pressure in the pneumatic glove according to the expected movement trend, so that the pneumatic glove moves according to the expected movement trend, to drive the hand of the patient to move when it is determined that the hand of the patient has a stretching movement trend includes:

controlling, by the control part, the pneumatic device to output negative pressure to the pneumatic glove until the air pressure in the pneumatic glove reaches a negative pressure extreme value, so that the pneumatic glove assists the hand of the patient to carry out the stretching movement for a period of stretching time.

After the hand of the patient is determined to have a stretching movement trend, the pneumatic device outputs negative pressure to the pneumatic glove, and the pneumatic glove stretches to drive the hand of the patient to carry out the stretching movement, so as to realize the rehabilitation training of the power-assisted stretching movement of the hands of the patient.

Further, a negative pressure extreme value is −80 kPa to −55 kPa, wherein the stretching time can be arbitrarily selected. In an embodiment, the pneumatic glove maintains the stretching time of the negative pressure extreme value for 3 to 12 seconds.

The negative pressure extreme value in an embodiment of the present application is −70 kPa, so that the hand of the patient can reach a fully stretching state and the effect of rehabilitation training can be improved.

Further, when it is determined that the hand of the patient has a flexion movement trend, the specific process that the control part regulates the output air pressure of the pneumatic device to control a movement state of the pneumatic glove, so that the pneumatic glove moves according to the expected movement trend and drives the hand of the patient to move includes:

The control part controls the pneumatic device to output positive pressure to the pneumatic glove until the air pressure in the pneumatic glove reaches a positive pressure extreme value, so that the pneumatic glove assists the hand of the patient to carry out flexion movement for a period of flexion time.

After the hand of the patient is determined to have a flexion movement of trend, the pneumatic device outputs positive pressure to the pneumatic glove, and the flexion movement of the pneumatic glove drives the hand of the patient to carry out the flexion movement, so as to realize the rehabilitation training of the power-assisted flexion movement of the hands of the patient.

Further, a positive pressure extreme value is 90 kPa to 130 kPa, and the flexion time can be arbitrarily selected. Preferably, the positive pressure extreme value is 110 kPa, and the flexion time is 3 to 12 seconds, so that the hand of the patient reaches a state of full first clenching after flexion, and the effect of rehabilitation training is improved.

Further, after the pneumatic glove moves according to the expected movement trend and drives the hand of the patient to move, the method further includes:

causing the pneumatic glove to return to a natural flexion state by turning on an on-off switch or controlling the pneumatic device to output air pressure to the pneumatic glove through the control part.

The specific process of causing the pneumatic glove to return to a natural flexion state by controlling the pneumatic device to output air pressure to the pneumatic glove through the control part includes:

measuring the internal air pressure value of the pneumatic glove and determining the internal air pressure value to be positive or negative;

controlling, by the control part, the pneumatic device to output negative pressure to the pneumatic glove until the pneumatic glove returns to the natural flexion state when the internal air pressure value is determined to be positive; and

controlling, the control part, the pneumatic device to output positive pressure to the pneumatic glove until the pneumatic glove returns to the natural flexion state when the internal air pressure value is determined to be negative.

According to the air pressure inside the pneumatic glove, the pneumatic device is correspondingly regulated to output the opposite air pressure to the pneumatic glove, so that the air pressure inside the pneumatic glove is restored to the atmospheric pressure state, and the pneumatic glove is restored to the natural flexion state, so as to facilitate the next training process.

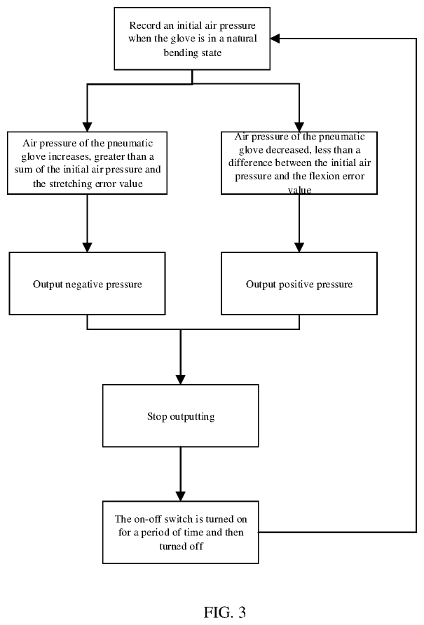

As shown in FIG. 3, a specific embodiment will now be described:

When the patient wears the pneumatic glove, since there is no pneumatic device to output power, the pneumatic glove is in a natural flexion state (that is, a semi-flexion state), a current air pressure of the pneumatic glove at a current moment is recorded, and a difference between the current air pressure of the pneumatic glove and the standard atmospheric pressure is taken as an initial air pressure (the pressure is positive when the initial air pressure is greater than 0 and negative when the initial air pressure is less than 0). Since the atmospheric pressure value will be affected by altitude, weather and other factors, the measured air pressure value in the pneumatic glove will fluctuate. In the embodiment, the initial air pressure usually ranges between −5 kPa and 10 kPa.

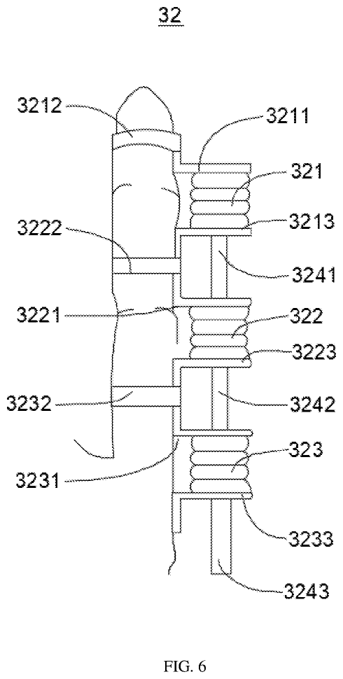

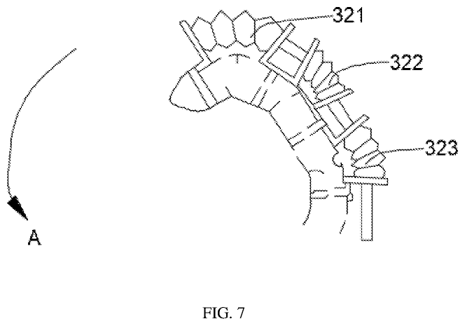

Specifically, FIG. 5 is a detailed structural schematic diagram of the pneumatic glove. The pneumatic glove has a second glove body 31, a first movement assistance unit 32 provided at an index finger portion of the second glove body 31, a second movement assistance unit 36 provided at a thumb portion of the second glove body 31, a third movement assistance unit 37 provided at a middle finger portion of the second glove body 31, a fourth movement assistance unit 38 provided at a ring finger portion of the second glove body 31, a fifth movement assistance unit 39 provided at a little finger portion of the second glove body 31, a second junction box 33, a housing member 34, and a second connector 35. The second glove body 31 is used for a patient to wear on the hand, wherein the movement assistance units adopt a bellows structure. FIG. 6 is a structural schematic diagram of the first movement assistance unit shown in FIG. 5, and FIG. 7 is a schematic diagram of an operating state of the first movement assistance unit shown in FIG. 5 in which the first movement assistance unit performs a flexion movement.

Referring to FIG. 6, the first movement assistance unit 32 has a first bellows 321, a second bellows 322, a third bellows 323, a first airway (not shown), and a first bracket assembly (not shown). The first bracket assembly (not shown) has a first L-shaped bracket 3211, a second L-shaped bracket 3233, a first U-shaped bracket 3213, a second U-shaped bracket 3223, a first tie 3212, a second tie 3222, and a third tie 3232. The first airway (not shown) has a proximal airway 3241, a middle airway 3242, and a distal airway 3243.

Specifically, an outer side surface of a vertical plate of the first L-shaped bracket 3211 is fixedly connected to an upper end surface of the first bellows 321, an outer side surface of one vertical plate of the first U-shaped bracket 3213 is fixedly connected to a lower end surface of the first bellows 321, an outer side surface of the other vertical plate of the first U-shaped bracket is fixedly connected to an upper end surface of the second bellows 322, a horizontal plate of the first L-shaped bracket 3211 is bonded and fixed on a surface of the second glove body 31, and the fixed connection with the second glove body 31 is strengthened by the first tie 3212; and a horizontal plate of the first U-shaped bracket 3213 is bonded and fixed on the surface of the second glove body 31, and the fixed connection with a finger part of the second glove body 31 is strengthened by a second stop ring 3222, while the first bellows 321 being disposed across a joint between a distal phalanx and a middle phalanx of the hand is realized.

An outer side surface of one vertical plate of the second U-shaped bracket 3223 is fixedly connected to a lower end surface of the second bellows 322, in combination with a horizontal plate of the second U-shaped bracket 3223 being fixedly connected to a finger part of the second glove body 31 through a third stop ring 3232, so that the second bellows 322 is disposed across a joint between the middle phalanx and a proximal phalanx of the hand.

An outer side surface of the other vertical plate of the second U-shaped bracket 3223 is fixedly connected to an upper end surface of the third bellows 323, in combination with an outer side surface of a vertical plate of the second L-shaped bracket 3233 being fixedly connected to a lower end surface of the third bellows 323, and a horizontal plate of the second L-shaped bracket 3233 being fixedly connected to the second glove body 31, so that the third bellows 323 is disposed across a joint between the proximal phalanx and sesamoid.

The proximal airway 3241 is disposed between the two vertical plates of the first U-shaped bracket 3213 and penetrates the first U-shaped bracket 3213, so that the first bellows 321 is in interior communication with the second bellows 322; the middle airway 3242 is disposed between the two vertical plates of the second U-shaped bracket 3223 and penetrates the second U-shaped bracket 3223, so that the second bellows 322 is in interior communication with the third bellows 323; and one end of the distal airway 3243 penetrates the vertical plate of the second L-shaped bracket 3233 to be in interior communication with the third bellows 323, and the other end of the distal airway 3243 enters through one side of the second junction box 33 to be accommodated in an interior of the housing member 34.

As shown in FIG. 7, when a patient wears the pneumatic glove on the hand, moves the hand autonomously to cause fingers of the hand to move in a direction A shown in FIG. 7, that is, flexing the hand wearing on the pneumatic glove makes the pneumatic glove in a flexion state by a flexion movement, the first bellows 321, the second bellows 322, and the third bellows 323 have certain elongation so that volumes of the first bellows 321, the second bellows 322, and the third bellows 323 are increased, a pressure of the air inside the first movement assistance unit 32 is reduced, and the air pressure is reduced. Similarly, when the patient autonomously moves the hand wearing on the pneumatic glove to cause the fingers of the hand to slightly move in an opposite direction of the direction A (i.e., the stretching direction), the first bellows 321, the second bellows 322, and the third bellows 323 of the pneumatic glove are compressed to a certain extent so that the volumes of the first bellows 321, the second bellows 322, and the third bellows 323 are reduced, a pressure of the air inside the first movement assistance unit 32 is increased, and the air pressure is increased, so that an air pressure change can be generated according to the movement of the patient.

The pneumatic glove is connected to internal air paths of a main device through the output port, so that the air pressure change is measured by the air pressure measurement unit in real time and sent to the control part, which is convenient for the control part to determine the movement trend according to the air pressure change.

Moreover, the air pressure stretching threshold and the air pressure flexion threshold are set according to the initial air pressure value, the stretching error value and the flexion error value. The stretching error value is 5 to 17 kPa and the flexion error value is 5 to 11 kPa. In this embodiment, when a stretching error value Y is set to 11 kpa and a flexion error value Z is set to 8 kPa, the air pressure stretching threshold is a sum of the initial air pressure and the stretching error value, and the air pressure flexion threshold is a difference between the initial air pressure and the flexion error value.

The specific process of determining a magnitude between the current air pressure, the air pressure stretching threshold and the air pressure flexion threshold when the air pressure inside the pneumatic glove changes due to the hand motion of the patient includes:

determining that the hand of the patient has a stretching movement trend when the measured air pressure value received by the control part is greater than the air pressure stretching threshold, and the control part controlling the pneumatic device to output negative pressure of 90 kPa to 130 kPa, preferably 110 kPa for a second(s), so that the pneumatic glove assists the hand of the patient to make the stretching movement and completely stretch;

determining that the hand of the patient has a flexion movement trend when the air pressure value received by the control part is less than the air pressure flexion threshold, the control part controlling the pneumatic device to output positive pressure of 90 kPa to 130 kPa, preferably 110 kPa, so that the pneumatic glove assists the hand of the patient to make the flexion movement and reach a state of fully clenching a fist, and the control part controlling the pneumatic device to stop outputting the positive pressure after an output time of the positive pressure is a second(s).

In the above process, the output time a of positive pressure and negative pressure is 3 to 12 seconds.

After completing the power-assisted training, the control part controls the pneumatic device to stop outputting air to the pneumatic glove for b second(s), and controls to turn on the on-off switch on the pneumatic glove, so that the air paths in the pneumatic glove are connected to the external atmosphere, thereby releasing the air pressure inside the air paths of the pneumatic glove, so that the gloves can be restored to the natural flexion state (i.e., the semi-flexion state) in a short time. Then the control part controls to turn off the on-off switch again after c second(s) to restore airtight spaces of the air paths inside the whole pneumatic glove, thus completing a training cycle. In the subsequent process, measurement of the air pressure change inside the pneumatic glove caused by the hand motion of the patient is performed, and then the power-assisted training process is repeated as the above-mentioned. That is to say, before the air pressure change is detected inside the pneumatic glove caused by the hand motion of the patient, the air path of the pneumatic glove is closed.

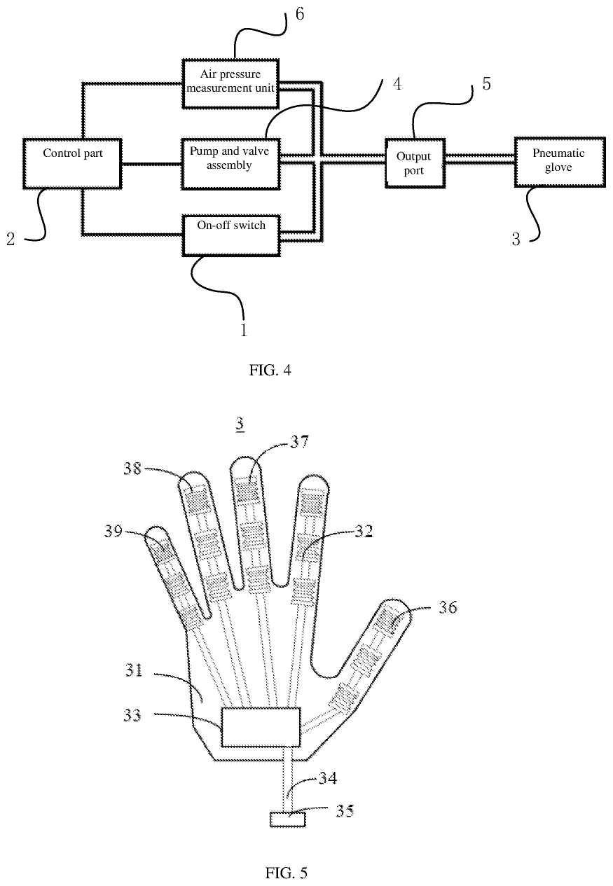

As shown in FIG. 4, the present disclosure further provides a device for power-assisted training for a hand of a patient, including a pneumatic glove 3, a control part 2, an air pressure measurement unit 6 and a pneumatic device 4, wherein the pneumatic glove is pneumatically connected to the pneumatic device 4 through an output port 5, the control part 2 is connected to the pneumatic device 4 to control the pneumatic device 4 so that the pneumatic device 4 outputs positive pressure, negative pressure or stops output to the pneumatic glove 3, the air pressure measurement unit 6 is connected to the output port 5 to measure air pressure data of the pneumatic glove in real time, and an output terminal of the air pressure measurement unit 6 is electrically connected to the control part 2 to output the measured air pressure data.

Further, the air pressure measurement unit 6 can measure air pressure data of bellows in the pneumatic glove, a connecting parts between the bellows and an output port, and can also measure the air pressure data of the bellows of one or more fingers in the pneumatic glove, the connecting part between the bellows and the output port thereof, so as to accurately determine the air pressure condition of the pneumatic glove and facilitate the determination of the movement trend of the hand of the patient.

The specific working process of the device corresponds to the above method, so it will not be described here.

It should be noted that the pneumatic device 4 in the solution of the present application is mainly used for outputting positive pressure, negative pressure or stopping output, its main function is to regulate the air pressure in the pneumatic glove. In other words, the pneumatic device 4 has a positive pressure end and a negative pressure end. That the pneumatic device outputs positive pressure to the pneumatic glove means the positive pressure end of the pneumatic device is connected with the pneumatic glove, so that the pneumatic device can inflate the pneumatic glove. That the pneumatic device outputs negative pressure to the pneumatic glove means that the negative pressure end of the pneumatic device is connected to the pneumatic glove, so that the pneumatic device can extract air from the pneumatic glove. The solution of the present application does not involve an improvement on the pneumatic device 4 itself. Any existing equipment capable of realizing the air pressure output regulation in the present solution can be applied to the solution of the present application, and the present disclosure is not limited to this.

Further, the device further includes an on-off switch 1, the on-off switch 1 is connected to the output port 5 to control an on-off of the pneumatic glove and the external atmosphere, the on-off switch 1 is further electrically connected to the control part 2, and the on-off switch 1 is an electromagnetic switch.

The on-off switch 1 makes the air pressure inside the pneumatic glove and the external atmospheric pressure in a conductive state, thereby reducing the change speed of the air pressure inside the pneumatic glove and playing a protective role when training the hands of patients.

Further, when the power-assisted training is started, the pneumatic glove is in a natural flexion state, specifically, the air pressure inside the pneumatic glove is consistent with the air pressure of the external atmosphere, and the on-off switch 1 is in an on state, so that the pneumatic glove 3 is connected to the external atmosphere to be in a natural flexion state.

While the embodiments of the present disclosure have been described in detail, it will be apparent to those skilled in the art that various modifications and variations can be made to the embodiments. However, it is to be understood that such modifications and variations are within the scope and spirit of the present disclosure as described in the appended claims. Furthermore, the present disclosure described herein is susceptible to other embodiments and may be embodied or carried out in various ways.

What is claimed is:

1. A device for power-assisted training for a hand of a patient, comprising a pneumatic glove, a control part, an output port, an air pressure measurement unit and a pneumatic device, wherein the pneumatic glove is pneumatically connected to the pneumatic device through the output port, the control part is connected to the pneumatic device to control the pneumatic device, such that the pneumatic device outputs positive pressure, negative pressure or stops outputting to the pneumatic glove, the air pressure measurement unit is connected to the output port to measure air pressure data of the pneumatic glove in real time, and an output terminal of the air pressure measurement unit is electrically connected to the control part to output the measured air pressure data; a method for controlling, by a control part, a pneumatic glove, and the method comprising:
S1, regulating an air pressure of a pneumatic glove to enable the pneumatic glove to be in a natural flexion state, and obtaining a current air pressure value of the pneumatic glove, detected by an air pressure detection unit at a current moment, as an initial air pressure, wherein the natural flexion state refers to a state at which the air pressure in the pneumatic gloves is equal to an external air pressure;
S2, setting an air pressure threshold according to the initial air pressure, the air pressure threshold including an air pressure stretching threshold and an air pressure flexion threshold, wherein the air pressure stretching threshold is a sum of the initial pressure and a stretching error value, and the stretching error value is a pressure value greater than 0; the air pressure flexion threshold is a difference between the initial air pressure and a flexion error value, and the flexion error value is a pressure value greater than 0; adjusting an internal air path of the pneumatic gloves to a closed air path, and when the pneumatic glove is worn on a hand of a patient, obtaining a current air pressure of the pneumatic glove detected by the air pressure detection unit, and determining an expected movement trend of the hand of the patient according to the current air pressure and air pressure threshold;
S3, regulating the air pressure in the pneumatic glove according to the expected movement trend, such that the pneumatic glove moves according to the expected movement trend.

2. The device according to claim 1, wherein the device further comprises an on-off switch, the on-off switch is connected to the output port to control an on-off of the pneumatic glove and the external atmosphere, and the on-off switch is further electrically connected to the control part.

3. The device according to claim 1, wherein the step S3 comprises: when it is determined that the hand of the patient has the flexion movement trend, controlling a pneumatic device according to the expected movement trend to output positive pressure to the pneumatic glove until the air pressure in the pneumatic glove reaches a positive pressure extreme value, such that the pneumatic glove assists the hand of the patient to carry out a flexion movement and last for a period of flexion time, and the period of flexion time is 3-12 seconds.

4. The device according to claim 3, wherein a positive pressure extreme value is 90 kPa to 130 kPa.

5. The device according to claim 1, wherein the step S3 comprises: when it is determined that the hand of the patient has the stretching movement trend, controlling a pneumatic device according to the expected movement trend to output negative pressure to the pneumatic glove until the air pressure in the pneumatic glove reaches a negative pressure extreme value, such that the pneumatic glove assists the hand of the patient to carry out a stretching movement and last for a period of stretching time, and the period of stretching time is 3-12 seconds.

6. The device according to claim 5, wherein a negative pressure extreme value is −80 kPa to −55 kPa.

7. A method for controlling a pneumatic glove, the method comprising:
S1, regulating an air pressure of a pneumatic glove to enable the pneumatic glove to be in a natural flexion state, and obtaining a current air pressure value of the pneumatic glove, detected by an air pressure detection unit at a current moment, as an initial air pressure, wherein the natural flexion state refers to a state at which the air pressure in the pneumatic gloves is equal to an external air pressure;
S2, setting an air pressure threshold according to the initial air pressure, the air pressure threshold including an air pressure stretching threshold and an air pressure flexion threshold, wherein the air pressure stretching threshold is a sum of the initial pressure and a stretching error value, and the stretching error value is a pressure value greater than 0; the air pressure flexion threshold is a difference between the initial air pressure and a flexion error value, and the flexion error value is a pressure value greater than 0; adjusting an internal air path of the pneumatic gloves to a closed air path, and when the pneumatic glove is worn on a hand of a patient, obtaining the current air pressure of the pneumatic glove detected by the air pressure detection unit, and determining an expected movement trend of the hand of the patient according to the current air pressure and air pressure threshold;
S3, regulating the air pressure in the pneumatic glove according to the expected movement trend, such that the pneumatic glove moves according to the expected movement trend.

8. The method according to claim 7, wherein the stretching error value is 5 to 17 kPa, and the flexion error value is 5 to 11 kPa.

9. The method according to claim 8, wherein a process of the step S2 comprises:
determining that the hand of the patient has a stretching movement trend when the current air pressure is greater than the air pressure stretching threshold; and
determining that the hand of the patient has a flexion movement trend when the current air pressure is less than the air pressure flexion threshold.

10. The method according to claim 9, wherein the step S3 comprises: when it is determined that the hand of the patient has the stretching movement trend, controlling a pneumatic device according to the expected movement trend to output negative pressure to the pneumatic glove until the air pressure in the pneumatic glove reaches a negative pressure extreme value, such that the pneumatic glove assists the hand of the patient to carry out a stretching movement.

11. The method according to claim 9, wherein the step S3 comprises: when it is determined that the hand of the patient has the flexion movement trend, controlling a pneumatic device according to the expected movement trend to output positive pressure to the pneumatic glove until the air pressure in the pneumatic glove reaches a positive pressure extreme value, such that the pneumatic glove assists the hand of the patient to carry out a flexion movement.

12. The method according to claim 7, wherein after the pneumatic glove moves according to the expected movement trend, the method further comprises:
causing the pneumatic glove to return to a natural flexion state by turning on an on-off switch or controlling the pneumatic device to output air pressure to the pneumatic glove.

13. The method according to claim 12, wherein causing the pneumatic glove to return to a natural flexion state by controlling the pneumatic device to output air pressure to the pneumatic glove comprises:
obtaining an internal air pressure value of the pneumatic glove detected by an air pressure detection unit;
controlling the pneumatic device to output negative pressure to the pneumatic glove until the pneumatic glove returns to the natural flexion state when the internal air pressure value is determined to be positive; and
controlling the pneumatic device to output positive pressure to the pneumatic glove until the pneumatic glove returns to the natural flexion state when the internal air pressure value is determined to be negative.

14. The method according to claim 7, wherein the step S1 comprises: communicating the pneumatic glove with an external atmospheric pressure to keep the air pressure value in the pneumatic glove consistent with the external atmospheric pressure, such that the pneumatic glove is in the natural flexion state, and obtaining the air pressure value of the pneumatic glove, detected by an air pressure detection unit at a current moment, as the initial air pressure.

15. A method for controlling a pneumatic glove, the method comprising:
S1, regulating an air pressure of a pneumatic glove to enable the pneumatic glove to be in a natural flexion state, wherein the natural flexion state refers to a state at which the air pressure in the pneumatic gloves is equal to an external air pressure;
S2, adjusting an internal air path of the pneumatic gloves to a closed air path, and when the pneumatic glove is worn on a hand of a patient, obtaining a change rate of a current air pressure of the pneumatic glove detected by an air pressure detection unit, and determining an expected movement trend of the hand of the patient according to the change rate of the current air pressure;
determining the hand of the patient has the stretching movement trend when the change rate of the current air pressure is greater than 0;
determining the hand of the patient has the flexion movement trend when the change rate of the current air pressure is less than 0; and
S3, regulating the air pressure in the pneumatic glove according to the expected movement trend, such that the pneumatic glove moves according to the expected movement trend.

16. The method according to claim 15, wherein the step S3 comprises: when it is determined that the hand of the patient has the stretching movement trend, controlling a pneumatic device according to the expected movement trend to output negative pressure to the pneumatic glove until the air pressure in the pneumatic glove reaches a negative pressure extreme value, such that the pneumatic glove assists the hand of the patient to carry out a stretching movement.

17. The method according to claim 15, wherein the step S3 comprises: when it is determined that the hand of the patient has the flexion movement trend, controlling a pneumatic device according to the expected movement trend to output positive pressure to the pneumatic glove until the air pressure in the pneumatic glove reaches a positive pressure extreme value, such that the pneumatic glove assists the hand of the patient to carry out a flexion movement.

18. The method according to claim 15, wherein after the pneumatic glove moves according to the expected movement trend, the method further comprises:
obtaining an internal air pressure value of the pneumatic glove detected by an air pressure detection unit;
controlling the pneumatic device to output negative pressure to the pneumatic glove until the pneumatic glove returns to the natural flexion state when the internal air pressure value is determined to be positive; and
controlling the pneumatic device to output positive pressure to the pneumatic glove until the pneumatic glove returns to the natural flexion state when the internal air pressure value is determined to be negative.

19. The method according to claim 15, wherein after the pneumatic glove moves according to the expected movement trend, the method further comprises:
communicating the pneumatic glove with an external atmospheric pressure to keep the air pressure value in the pneumatic glove consistent with the external atmospheric pressure by turning on an on-off switch, so that the pneumatic glove is in the natural flexion state.

20. The method according to claim 15, wherein the step S1 comprises: communicating the pneumatic glove with an external atmospheric pressure to keep the air pressure value in the pneumatic glove consistent with the external atmospheric pressure, so that the pneumatic glove is in the natural flexion state.
